(19) United States
(12) Patent Application Publication
(10) Pub. No.: US 2012/0117357 A1
(43) Pub. Date: May 10, 2012

(54) ENERGY TILE PROCESSOR

(75) Inventor: Young-Su Kwon, Daejeon (KR)

(73) Assignee: ELECTRONICS AND TELECOMMUNICATIONS RESEARCH INSTITUTE, Daejeon (KR)

(21) Appl. No.: 13/280,370

(22) Filed: Oct. 25, 2011

(30) Foreign Application Priority Data
Nov. 8, 2010 (KR) 10-2010-0110659

(51) Int. Cl. G06F 15/78; G06F 9/312; G06F 9/30

(52) U.S. Cl. 712/1; 712/E09.016; 712/E09.028; 712/E09.033

(57) ABSTRACT

An energy tile processor in which an internal structure of a single processor is divided into a part for supplying instructions and another part for executing the instructions in order for operating voltages and operating frequencies to be supplied independently. The processor includes an instruction supply unit storing instructions and issuing instructions to be executed, a first execution unit executing an integer operation and a memory operation according to an operation type of the instruction issued by the instruction supply unit, and a second execution unit executing a floating point operation according to an operation type of the instruction issued by the instruction supply unit. The instruction supply unit, the first execution unit, and the second execution unit are driven at operating voltages and operating frequencies which are independently controlled.

### CROSS-REFERENCE TO RELATED APPLICATIONS

The present application claims priority to Korean patent application number 10-2010-0110659, filed on Nov. 8, 2010, which is incorporated by reference in its entirety.

### BACKGROUND OF THE INVENTION

The present invention relates to a mobile embedded processor, and more particularly, to an energy tile processor, in which an internal structure of a single processor is divided into a part for supplying instructions and another part for executing the instructions in order for operating voltages and operating frequencies to be supplied independently, and thus processor performance and energy consumption can be controlled by controlling the operating voltages and the operating frequencies.

A processor denotes hardware or an IP that executes an algorithm for a specific application by reading an instruction stored in a storage device such as a memory or disk, performing a specific operation for an operand based on an operation encoded in the instruction, and storing the operation result.

Such processor applications are widely applied across all system semiconductor fields.

Applications of processors are seeing wider use in a greater assortment of fields including: high performance media data processing for high volume multimedia data, such as compression and decompression of video and audio data, transformation of audio data, and sound effects; medium performance data processing for wired and wireless communication modems, speech processing algorithms, and network data processing; minimum performance microcontroller platforms such as touch screens, controllers for home appliances, and motor controllers; and devices (which cannot receive power stably or from the outside) such as wireless sensor networks and miniature electronic devices.

To date, industrial practice has generally been to apply dedicated processors according to the performance required by an application. Processors with high operating frequencies and large hardware footprints have been applied in fields requiring high performance, and processors with low operating frequencies and small hardware footprints have been applied in fields requiring low performance, thereby increasing energy efficiency.

Recently, the importance of mobile application processors that perform core functions in mobile terminals has been accentuated by the conspicuous explosive growth of mobile markets for smart phones, mobile internet devices (MID), smart TVs, etc. Since guarantees for high performance and prolonged use are important considerations for mobile processors, technology for minimizing energy consumption is a factor that determines mobile processor performance.

The technical configurations described above are examples of related art intended to facilitate an understanding of the present invention, and are not related art that is widely known in the technical field to which the present invention relates.

### SUMMARY OF THE INVENTION

Embodiments of the present invention are directed to an energy tile processor, in which an internal structure of a single processor is divided into a part for supplying instructions and another part for executing the instructions in order for operating voltages and operating frequencies to be supplied independently, and thus processor performance and energy consumption can be controlled by controlling the operating voltages and the operating frequencies.

In one embodiment, an energy tile processor includes: an instruction supply unit adapted to store instructions, and issue instructions to be executed; a first execution unit adapted to execute a integer operation and a memory operation according to an operation type of the instruction issued by the instruction supply unit; and a second execution unit adapted to execute a floating point operation according to an operation type of the instruction issued by the instruction supply unit, wherein the instruction supply unit, the first execution unit, and the second execution unit are driven at operating voltages and operating frequencies which are independently controlled, respectively, and wherein the instruction supply unit, the first execution unit, and the second execution unit control data bandwidth according to the operating voltages and operating frequencies which are independently controlled, respectively.

The instruction supply unit, the first execution unit, and the second execution unit may issue or execute the instructions at a high or low speed according to the operating voltages and operating frequencies which are independently controlled, respectively.

The instruction supply unit may include: an instruction cache adapted to store the instructions; an instruction queue adapted to read the instructions stored in the instruction cache, and adapted to store the read instructions temporarily; and an instruction sequencer adapted to read the instructions stored in the instruction queue, and sort the sequence of instructions for executing to issue the instructions to the first execution unit and the second execution unit.

The instruction queue may be connected to the instruction cache through an instruction cache data bus to read instructions assigned to successive addresses from the instruction cache during one clock cycle.

The instruction sequencer may be connected to the instruction queue through an instruction queue bus to simultaneously read a plurality of instructions from the instruction queue during one clock cycle.

The instruction sequencer may be connected to the first execution unit and the second execution unit through an instruction sequence bus to issue instructions to the first execution unit and the second execution unit.

### BRIEF DESCRIPTION OF THE DRAWINGS

FIG. 1 illustrates a block diagram of an energy tile processor according to one embodiment of the present invention.

### DESCRIPTION OF SPECIFIC EMBODIMENTS

Hereinafter, an energy tile processor in accordance with the present invention will be described in detail with reference to the accompanying drawings.

Hereinafter, the present invention will be described in more detail through embodiments. The embodiments are merely for exemplifying the present invention, and the right protection scope of the present invention is not limited by the embodiments.

In the drawings, the thicknesses of lines or the sizes of elements may be exaggeratedly illustrated for clarity and convenience of description. Moreover, the terms used henceforth have been defined in consideration of the functions of the present invention, and may be altered according to the intent of a user or operator, or conventional practice. Therefore, the terms should be defined on the basis of the entire content of this specification.

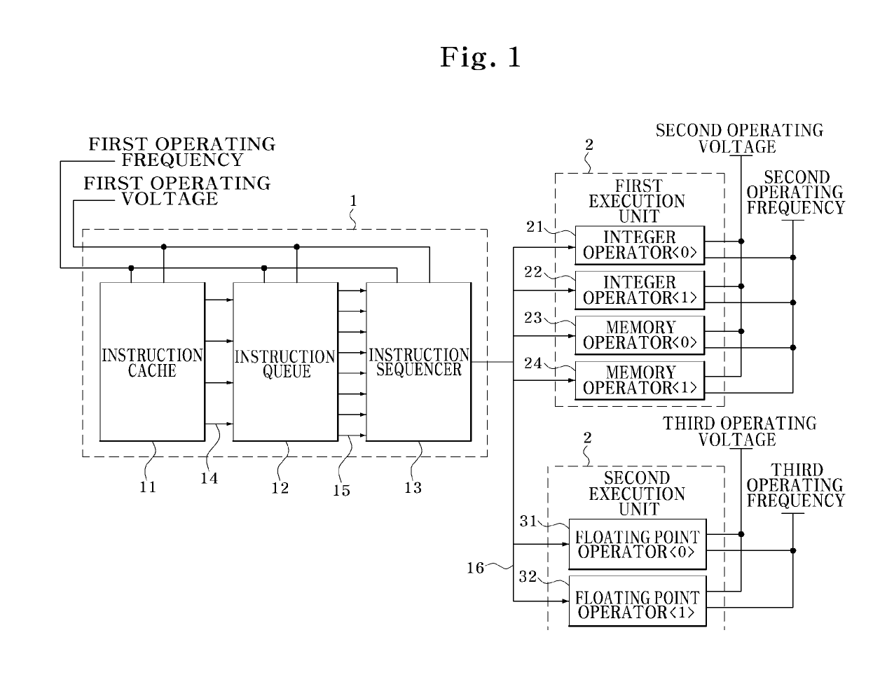

FIG. 1 illustrates a block diagram of an energy tile processor according to one embodiment of the present invention.

Referring to FIG. 1, an energy tile processor according to one embodiment of the present invention divides a single processor structure into an instruction supply unit 1, a first execution unit 2, and a second execution unit 3, each of which is driven at an operating voltage and an operating frequency that are controlled independently.

Herein, the operating voltage and the operating frequency are controlled according to factors such as instruction dependence, execution dependence and the number of instructions for executing, in which a plurality of instructions are received.

In the present invention, the single processor structure is divided into the instruction supply unit 1, the first execution unit 2 and the second execution unit 3, each of which is defined as an energy tile.

The instruction supply unit 1 stores instructions and issues instructions for executing to the first execution unit 2 and the second execution unit 3.

The instruction supply unit 1 includes an instruction cache 11 that stores instructions, an instruction queue 12 that reads the instruction stored in the instruction cache 11 and stores the instructions temporarily, and an instruction sequencer 13 that reads the instructions stored in the instruction queue 12 and sorts the sequence of the instructions to issue the instructions to the first execution unit 2 and the second execution unit 3.

The instruction cache 11 is configured with a memory such as a static random access memory (SRAM), and the instruction queue 12 is configured with a storage circuit such as a flip-flop.

Since the instruction queue 12 is configured with a flip-flop, the number of instructions that may be stored in the instruction queue 12 is relatively less compared to the instruction cache 11. The instruction queue 12 may read 1 to 4 instructions from the instruction cache 11.

In a specific clock cycle, the number of instructions that the instruction queue 12 reads from the instruction cache 11 is determined according to the number of instructions currently stored in the instruction queue 12.

The instruction sequencer 13 reads the instructions stored in the instruction queue 12, sorts the sequence of instructions for executing, and then issues the instructions to the first execution unit 2 and the second execution unit 3.

The first execution unit 2 includes two integer operators 21 and 22 that execute an integer operation and two memory operators 23 and 24 that execute a memory operation, according to the operation type of instruction issued by the instruction supply unit 1.

The second execution unit 3 includes two floating point operators 31 and 32 that execute a floating point operation according to the operation type of instruction issued by the instruction supply unit 1.

The instruction queue 12 is connected to the instruction cache 11 through an instruction cache data bus 14 so as to read instructions assigned to successive addresses from the instruction cache 11 during one clock cycle.

The instruction sequencer 13 is connected to the instruction queue 12 through an instruction queue bus 15 so as to simultaneously read a plurality of instructions from the instruction queue 12 during one clock cycle.

The instruction sequencer 13 is connected to the first execution unit 2 and the second execution unit 3 through an instruction sequence bus 16 so as to simultaneously issue the instructions to the first execution unit 2 and the second execution unit 3.

Since a plurality of execution units are in the processor, a plurality of instructions are issued to execution units so as to execute the instructions, during the same clock cycle.

Since data dependence and execution dependence may exist between instructions for simultaneously issuing a plurality of instructions to execution units, the instructions need to be sorted for removing the dependences.

In particular, the execution dependence denotes dependence occurring between instructions in a loop operation, i.e., when a series of instructions or instruction blocks are repetitively executed.

The instruction sequencer 13 removes the dependences. The instruction sequencer 13 simultaneously reads a plurality of instructions from the instruction queue 12, checks the dependences between the instructions, sorts the instructions in a type for removing the dependences, and then issues the instructions to corresponding execution units according to operation types of the instructions.

In this way, the present invention divides the single processor structure into a part for reading the instructions and another part for executing the instruction, supplies independent operating voltages and operating frequencies to drive the parts, and thus can operate the input/output data bandwidth of an energy tile and control an issue rate of instructions. Accordingly, the present invention can control performance and energy consumption of the energy tile.

Since each energy tile is driven at an independent operating voltage and operating frequency, operation of the tile is putted in a low-speed execution mode when a low voltage is supplied, but operation of the tile is putted in a high-speed execution mode when a high voltage is supplied.

In the low-speed execution mode, energy consumption decreases because an operation speed is low and a low voltage is supplied. In the high-speed execution mode, however, energy consumption increases because an operation speed is high and a high voltage is supplied.

Hereinafter, operations of the energy tile processor according to one embodiment of the present invention will be described.

Referring to FIG. 1, an instruction is first transmitted through the instruction cache data bus 14 between the instruction cache 11 and the instruction queue 12.

The instruction cache data bus 14 may read instructions of up to four which are assigned to successive addresses during one clock cycle.

However, the number of instructions that the instruction queue 12 read is determined according to the current state of the instruction queue 12, i.e., the number of instructions stored in the instruction queue 12 and the number of instructions storable in the instruction queue 12.

The number of instructions that the instruction queue 12 read through the instruction cache data bus 14 is expressed as Equation (1) below.

N=min(E_{IQ}, 4) (1)

where N is the number of instructions that the instruction queue 12 reads from the instruction cache 11 during one clock cycle, E_{IQ} is the number of instructions that may be further stored in the instruction queue 12, and the less number from among the two numbers is selected.

The instruction sequencer 13 reads instructions through the instruction queue bus 15, and then sorts the sequence of the instructions.

The instruction queue bus 15 may read eight instructions at one time.

The instruction sequencer 13 issues an instruction to an execution unit by sorting the instructions. The issued instruction informs the instruction queue 12 that a corresponding instruction in the instruction queue 12 has been executed, and allows the instruction queue 12 to store unissued instructions in order for the unissued instructions to be executed during the next clock cycle.

The instruction sequence bus 16 is one through which the instruction sequencer 13 issues instructions to the first execution unit 2 and the second execution unit 3.

The instruction sequencer 13 issues instructions to the execution units 2 and 3 suitable according to the kinds of operations performed by the issued instructions. The execution units 2 and 3 execute the operations of the instructions.

Each energy tile is driven at an independent operating voltage and operating frequency. The energy tile performs a corresponding function at a low speed when the operating voltage is low, but at a high speed when the operating voltage is high.

If the instruction supply unit 1, the first execution unit 2, and the second execution unit 3 are set to operate at a high voltage in an operating system, the instruction supply unit 1, the first execution unit 2, and the second execution unit 3 operate at a high speed.

In the best case where there is no dependence between instructions, the number of the instructions read through the instruction cache bus 14 is four at every clock cycle and the four instructions are issued to the first execution unit 2 and the second execution unit 3 through the instruction sequence bus 16 at every clock cycle.

An energy mode is putted in a high energy mode because the operating voltage is high and all the execution units 2 and 3 operate.

If the instruction supply unit 1 is set to operate at a high voltage and the first execution unit 2 and the second execution unit 3 are set to operate at a low voltage in the operating system, instructions are slowly executed because the operation speeds of the first and second execution units 2 and 3 become slower.

As a result, a speed at which instructions are issued through the instruction sequence bus 16, i.e., an issue speed decreases.

When the issue speed of an instruction decreases, a less number of instructions are transmitted through the instruction cache bus 14.

In this case, throughput of a processor is reduced, but energy consumption of the first and second execution units 2 and 3 decrease. This is favorable when dependence between instructions is high.

Although the instruction supply unit 1, the first execution unit 2 and the second execution unit 3 are driven at a high voltage, a sufficient number of instructions may not be issued to the first execution unit 2 and the second execution unit 3 through the instruction sequence bus 16 due to instruction dependence.

At this point, the instruction supply unit 1 operates at a normal speed, but since the number of instructions issued to the first and second execution units 2 and 3 is reduced, energy consumption can decrease by operating the first and second execution units 2 and 3 at a low speed.

When the instruction supply unit 1 operates at a low voltage and the first and second execution units 2 and 3 operate at a high voltage in the operating system, a sufficient number of instructions may be executed through the instruction sequence bus 16, but the number of instructions read through instruction cache bus 14 increases.

In this case, energy consumption can decrease and throughput can be maintained. The number of instructions that instruction cache bus 14 may read during one clock cycle may be insufficient. That is, a voltage drop of a sequencer tile is required to be controlled.

If each energy tile operates at a low voltage in the operating system, throughput of a processor is reduced, but energy consumption decreases. In this case, a plurality of instructions are variably issued through the instruction cache bus 14 and the instruction sequence bus 16 according to instruction dependence.

That is, energy consumption and processor throughput may be arbitrarily controlled by independently controlling the operating voltage and operating frequency of an energy tile configuring a single processor.

A method for controlling independent operating voltages and operating frequencies enables energy consumption to be controlled more finely according to the dependence and desired performance of instructions currently processed by a processor than a method for controlling the total voltages of a processor.

As described above, the present invention divides an internal structure of a single processor into a part for supplying instructions and another part for executing the instructions in order for operating voltages and operating frequencies to be supplied independently, and thus processor performance and energy consumption can be controlled by controlling the operating voltages and the operating frequencies.

While the present invention has been described with respect to the specific embodiments, it will be apparent to those skilled in the art that various changes and modifications may be made without departing from the spirit and scope of the invention as defined in the following claims.

What is claimed is:

1. An energy tile processor comprising:
an instruction supply unit adapted to store instructions, and issue instructions to be executed;
a first execution unit adapted to execute a integer operation and a memory operation according to an operation type of the instruction issued by the instruction supply unit; and
a second execution unit adapted to execute a floating point operation according to an operation type of the instruction issued by the instruction supply unit,
wherein the instruction supply unit, the first execution unit, and the second execution unit are driven at operating voltages and operating frequencies which are independently controlled, respectively, and
wherein the instruction supply unit, the first execution unit, and the second execution unit control data bandwidth according to the operating voltages and operating frequencies which are independently controlled, respectively.

2. The energy tile processor of claim 1, wherein the instruction supply unit, the first execution unit, and the second execution unit issue or execute the instructions at a high or low speed according to the operating voltages and operating frequencies which are independently controlled, respectively.

3. The energy tile processor of claim 1, wherein the instruction supply unit comprises:
an instruction cache adapted to store the instructions;
an instruction queue adapted to read the instructions stored in the instruction cache, and storing the read instructions temporarily; and
an instruction sequencer adapted to read the instructions stored in the instruction queue, and sort the sequence of instructions for executing to issue the instructions to the first execution unit and the second execution unit.

4. The energy tile processor of claim 3, wherein the instruction queue is connected to the instruction cache through an instruction cache data bus to read instructions assigned to successive addresses from the instruction cache during one clock cycle.

5. The energy tile processor of claim 3, wherein the instruction sequencer is connected to the instruction queue through an instruction queue bus to simultaneously read a plurality of instructions from the instruction queue during one clock cycle.

6. The energy tile processor of claim 3, wherein the instruction sequencer is connected to the first execution unit and the second execution unit through an instruction sequence bus to issue instructions to the first execution unit and the second execution unit.
